(19) United States
(12) Patent Application Publication
(10) Pub. No.: US 2005/0084442 A1
(43) Pub. Date: Apr. 21, 2005

(54) Chemical reprocessing method, chemical reprocessing apparatus, and method of manufacturing fluorite

(75) Inventor: Koji Yashima, Sakata-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/922,097

(22) Filed: Aug. 20, 2004

(30) Foreign Application Priority Data
Aug. 28, 2003 (JP) 2003-304589
May 25, 2004 (JP) 2004-154689

(51) Int. Cl. C01F 11/22

(52) U.S. Cl. 423/497; 422/68.1; 422/105; 422/107

(57) ABSTRACT

To make it possible to recover calcium fluoride with a high purity that can be used in semiconductor manufacturing in a method that recovers calcium fluoride by having hydrofluoric acid in an etchant waste liquid contact calcium carbonate; a chemical reprocessing method, which includes hydrofluoric acid used in a semiconductor manufacturing process, includes producing calcium fluoride by causing a used chemical including hydrofluoric acid to react with calcium carbonate, the calcium fluoride being produced starting from a state where a pH exceeds 7 and the calcium fluoride is recovered from a reaction column when the pH becomes 7 or below.

### BACKGROUND OF THE INVENTION

1. Field of Invention

Exemplary aspects of the present invention relate to a chemical reprocessing method, a chemical reprocessing apparatus, and a method of manufacturing fluorite, and specifically relate to a technique to recover calcium fluoride (fluorite) of a high purity from a used chemical (hereinafter “hydrofluoric acid waste liquid”) that includes hydrofluoric acid and is discharged by a semiconductor manufacturing process.

2. Description of Related Art

In the field of semiconductor manufacturing and in related fields, such as the field of surface treatments, a large amount of etchant is used, so that waste liquid including mainly HF (hydrofluoric acid) is discharged.

In related art methods of recovering and recycling (reusing) the hydrofluoric acid from a hydrofluoric acid waste liquid, it is possible to recover the hydrofluoric acid waste liquid in that state or to recover the hydrofluoric acid as fluorite.

When the hydrofluoric acid waste liquid is recovered in that state, a chemical that includes hydrofluoric acid, used when etching a construction (formed films) on a semiconductor substrate (wafer), is recovered in that state. In the case of recovery as fluorite, the used hydrofluoric acid waste liquid is made to react with lime (calcium carbonate) and is recovered as calcium fluoride (fluorite). See Japanese Unexamined Patent Publication No. H05-293475 and Japanese Unexamined Patent Publication No. 2001-137864. In either case, the recovered material is transported to a chemical manufacturer and is recycled to become hydrofluoric acid once again.

### SUMMARY OF THE INVENTION

In these related art methods, when the waste liquid is recovered as hydrofluoric acid waste liquid, such liquid includes a large amount of impurities that become mixed in during etching of the semiconductor. When the hydrofluoric acid is recovered as fluorite, if the lime is loaded into a reaction column in lumps and the waste liquid is progressively introduced, a large amount of unreacted lime (in particular, the centers of the lumps) will remain as an impurity and so will be recovered. So the purity of the recycled fluorite is low and is of an insufficiently high grade for use in semiconductor manufacturing, and so can only be put to ordinary industrial uses, such as the manufacturing of steel (such as stainless steel) or the manufacturing of resins.

Fluorite of a high purity with few impurities is required as a raw material for the hydrofluoric acid used when manufacturing semiconductors. This means that naturally occurring fluorite is used, with high grade fluorite with a purity of 98% being mainly used.

Exemplary aspects of the present invention address the above and/or other problems, and provide a chemical reprocessing method, a chemical reprocessing apparatus, and a method of manufacturing fluorite that can recover calcium fluoride of a high purity that can be used in semiconductor manufacturing as part of a method of recovering calcium fluoride by bringing hydrofluoric acid present in etchant waste liquid into contact with calcium carbonate.

To address or achieve the above, a chemical reprocessing method of a first exemplary aspect of the present invention is a method that includes hydrofluoric acid used in a semiconductor manufacturing process, including a step of producing calcium fluoride by causing a used chemical, including hydrofluoric acid, to react with calcium carbonate. The calcium fluoride is produced starting from a state where a pH exceeds 7 and the calcium fluoride is recovered when the pH becomes 7 or below.

According to this exemplary method of the present invention, the majority of the calcium carbonate (lime) reacts with the applied hydrofluoric acid waste liquid, so that calcium fluoride (fluorite) of a high purity that hardly includes any unreacted impurity can be recovered.

A chemical reprocessing method of a second exemplary aspect of the present invention is a method that recovers calcium fluoride by gradually applying a used chemical, which includes hydrofluoric acid and has been discharged by a semiconductor manufacturing process, to a reaction system loaded with calcium carbonate and causing the chemical to react with the calcium carbonate, including measuring a pH of the reaction system and recovering the calcium fluoride when it has been detected that the reaction system has changed from a calcium carbonate dominant state to a fluorine dominant state.

According to this exemplary method of the present invention, the majority of the calcium carbonate (lime) reacts with the applied hydrofluoric acid waste liquid, so that calcium fluoride (fluorite) of a high purity that hardly includes any unreacted impurity can be recovered.

A chemical reprocessing method of a third exemplary aspect of the present invention is a method that recovers calcium fluoride by gradually applying a used chemical, which includes hydrofluoric acid and has been discharged by a semiconductor manufacturing process, to a reaction system loaded with calcium carbonate and causing the chemical to react with the calcium carbonate, including measuring a pH of the reaction system, ending a reaction when the pH has become 7 or below, and recovering the calcium fluoride.

According to this exemplary method of the present invention, the majority of the calcium carbonate (lime) reacts with the applied hydrofluoric acid waste liquid, so that calcium fluoride (fluorite) of a high purity that hardly includes any unreacted impurity can be recovered.

A chemical reprocessing method of a fourth exemplary aspect of the present invention is a method that recovers calcium fluoride by gradually applying a used chemical, which includes hydrofluoric acid and has been discharged by a semiconductor manufacturing process, to a reaction system loaded with calcium carbonate and causing the chemical to react with the calcium carbonate. A chemical produced after lightly etching a surface of a substrate which a film has been formed with strong hydrofluoric acid during a semiconductor manufacturing process is used as the used chemical including hydrofluoric acid.

According to this exemplary method of the present invention, it is possible to use waste liquid that is a strong hydrofluoric acid (where the ratio hydrofluoric acid:water=1:1, 1:10, etc.) in which impurities, such as phosphorous, are not mixed as the hydrofluoric acid waste liquid to recover fluorite, so that it is possible to reduce the amount of impurities in the fluorite produced by causing the waste liquid to react with the calcium carbonate (lime) and to reduce the amount of impurities included in the discharged liquid after the production of fluorite.

A chemical reprocessing method of a fifth exemplary aspect of the present invention is a method that recovers calcium fluoride by gradually applying a used chemical, which includes hydrofluoric acid and has been discharged by a semiconductor manufacturing process, to a reaction system loaded with calcium carbonate and causing the chemical to react with the calcium carbonate. A chemical produced after lightly etching a surface of a substrate on which a film has been formed with strong hydrofluoric acid during a semiconductor manufacturing process is used as the used chemical including hydrofluoric acid. The method includes measuring a pH of the reaction system, ending a reaction when the pH has become 7 or below, and recovering the calcium fluoride.

According to this exemplary method of the present invention, the majority of the calcium carbonate (lime) reacts with the applied hydrofluoric acid waste liquid, so that calcium fluoride (fluorite) of a high purity that hardly includes any unreacted impurity can be recovered. Additionally, it is possible to use, as the hydrofluoric acid waste liquid used to recover fluorite, waste liquid provided by strong hydrofluoric acid (where hydrofluoric acid:water=1:1, 1:10 or the like) in which impurities, such as phosphorus, are not mixed, so that it is possible to reduce the amount of impurities in the fluorite produced by causing the hydrofluoric acid waste liquid to react with the calcium carbonate (lime) and to reduce the amount of impurities included in the discharged liquid after the production of fluorite.

In a sixth exemplary aspect of the present invention, the pH at an end of a reaction may be set at 7 to 5. According to this exemplary method of controlling the pH, it is possible to cause the majority of the calcium carbonate (lime) to react with the hydrofluoric acid waste liquid, so that fluorite of a high purity can be recovered.

In a seventh exemplary aspect of the present invention, it is preferable for the pH at the end of the reaction to be set at 7 to 3. According to this method of controlling the pH, it is possible to recover fluorite of a higher purity.

It should be noted that in the post-processing following the end of the reaction (waste water treatment), by applying the waste liquid to slaked lime and polyaluminum chloride, it is possible to reduce the likelihood or prevent the discharge of waste liquid whose fluorine concentration exceeds the emission standards set by the Water Pollution Control Law of Japan and the standards set for the factories, which means that the waste liquid can be prevented from having an adverse effect on the environment.

A chemical reprocessing method of an eighth exemplary aspect of the present invention is a method that recovers hydrofluoric acid from a used chemical by applying the used chemical, which includes hydrofluoric acid and has been discharged by a manufacturing process for an electronic device, to a reaction system loaded with calcium carbonate and causing the hydrofluoric acid to react with the calcium carbonate to produce calcium fluoride. The method includes measuring a pH of the reaction system in which the used chemical has been introduced; and ending a reaction between the hydrofluoric acid and the calcium carbonate in the reaction system when a measured value of the pH becomes at least 7 or below and recovering the calcium fluoride from the reaction system.

Here, an “electronic device” may be a semiconductor device or an LCD (Liquid Crystal Display), for example. The manufacturing processes of such electronic devices include, for example, processes such as the formation of a film of silicon oxide (SiO₂) on a substrate and the light etching of the surface of an SiO₂ film with strong hydrofluoric acid.

According to the above chemical reprocessing method, it is possible to recover calcium fluoride (fluorite) with a purity of 90% or above.

A chemical reprocessing method of a ninth exemplary aspect of the present invention is the chemical reprocessing method of the eight aspect, where the reaction between the hydrofluoric acid and the calcium carbonate in the reaction system is ended when the measured value of the pH becomes 5 or below or 3 or above and the calcium fluoride is recovered from the reaction system.

According to the chemical reprocessing method of the ninth exemplary aspect of the present invention, it is possible for the purity of the calcium fluoride (fluorite) recovered from the reaction system to approach 98%. It is therefore possible to obtain high-quality calcium fluoride that is close to natural fluorite (approximately 98% pure) and, with the obtained calcium fluoride as a raw material, it is possible to produce high-grade hydrofluoric acid that can be used in semiconductor manufacturing, for example.

The chemical reprocessing method of a tenth exemplary aspect of the present invention is the chemical reprocessing method of the eighth or ninth aspect, further including removing impurities from the used chemical that includes the hydrofluoric acid and has been discharged from the manufacturing process of the semiconductor device and then introducing the used chemical from which the impurities have been removed into the reaction system in which the calcium carbonate has been loaded. Here, the “impurities” may be phosphorous (P) and boron (B), for example.

According to the chemical reprocessing method of the tenth exemplary aspect of the present invention, it is possible to recover calcium fluoride (fluorite) of a high purity that hardly includes any impurities, such as phosphorous and boron.

The chemical reprocessing method of an eleventh exemplary aspect of the present invention is the method according to either the eight aspect or ninth aspect, where only the used chemical discharged from a process, out of the manufacturing process of an electronic device, before formation of an interlayer dielectric film is introduced into the reactive system in which the calcium carbonate has been loaded.

Here, the “interlayer dielectric film” is a film that is provided between a lower layer and an upper layer that are both conductive and electrically insulates and isolates these layers. As examples, BPSG (boron phosphosilicate glass) film or a PSG (phosphosilicate glass) film can be used as this interlayer dielectric film. A BPSG film includes phosphorous and boron, while a PSG film includes phosphorous.

According to the chemical reprocessing method of the eleventh aspect, it is possible to recover highly pure calcium fluoride that hardly includes any impurities such as phosphorous and boron.

The chemical reprocessing method of a twelfth exemplary aspect of the present invention is the chemical reprocessing method of any of the eighth through the eleventh aspect, a predetermined fluorine absorbing agent is applied to the used chemical for which the reaction between the hydrofluoric acid and the calcium carbonate has been ended to reduce a fluorine concentration of the used chemical.

Here, the concentration of fluorine in the reaction system tends to increase as the pH of the reaction system falls (see FIG. 4). Also, one or any combination of a) to c) below is used as a fluorine absorbing agent.
a) Slaked lime (Ca(OH)₂)+polyaluminum chloride (PAC)
b) A rare earth (such as lanthanoid)
c) A chelating agent

According to the chemical reprocessing method of the twelfth aspect it is possible to suppress the fluorine concentration of the used chemical after recovery of the calcium fluoride to or below at least legally determined emission standards.

A chemical reprocessing apparatus of a thirteenth exemplary aspect of the present invention includes: a reaction column in which a used chemical that includes hydrofluoric acid and has been discharged from a manufacturing process of an electronic device is caused to react with calcium carbonate to produce calcium fluoride; a pH measuring device to measure a pH of the used chemical inside the reaction column; and a reaction controlling device to end a reaction between the hydrofluoric acid and the calcium carbonate inside the reaction column when a measured value for the pH produced by the pH measuring means has become at least 7 or below, where the calcium fluoride is recovered from inside the reaction column after the reaction has been ended.

According to the chemical reprocessing apparatus of the thirteenth aspect, it is possible to recover calcium fluoride (fluorite) with a purity of 90% or above.

A fourteenth exemplary aspect of the present invention, a method of manufacturing calcium fluoride (fluorite) by introducing a used chemical, which includes hydrofluoric acid and has been discharged from a manufacturing process for an electronic device, into a reaction system in which calcium carbonate has been loaded and causing the hydrofluoric acid to react with the calcium carbonate, including steps of: measuring a pH of the reactive system into which the used chemical has been introduced; ending a reaction between the hydrofluoric acid and the calcium carbonate in the reaction column when a measured value of the pH has become at least 7 or below; and recovering the calcium fluoride from the reaction column.

According to the method of manufacturing of the fourteenth aspect, it is possible to produce calcium fluoride (fluorite) with a purity of 90% or above using a used chemical which includes hydrofluoric acid and has been discharged from a manufacturing process for an electronic device. This means that it is possible to recycle fluorite, which contributes to reductions in the mined amount of fluorite.

### BRIEF DESCRIPTION OF THE DRAWINGS

FIG. 1 is a schematic showing the flow of a chemical reprocessing method according to an exemplary embodiment of the present invention;

FIG. 2 is a schematic showing an example construction of a chemical reprocessing apparatus 100 according to an exemplary embodiment of the present invention;

FIG. 3 is a schematic showing the flow of a semiconductor manufacturing process;

FIG. 4 is a schematic showing the relationship between the fluorine concentration [ppm] and the pH value when hydrofluoric acid waste liquid is applied to calcium carbonate; and

FIG. 5 is a schematic showing an example of an overall construction of a waste liquid processing system according to an exemplary embodiment of the present invention.

### DETAILED DESCRIPTION OF EXEMPLARY EMBODIMENTS

In the exemplary embodiments of the present invention, hydrofluoric acid waste liquid is caused to react with lime and is recovered as fluorite. But to increase the purity of the fluorite when doing so, the reaction with lime is conducted at above pH7 and the reaction is ended at pH7 or below.

It is hard for impurities from semiconductor etching included in the hydrofluoric acid waste liquid to enter the produced fluorite crystals. By also managing the pH during the recovery of fluorite, it is possible to produce fluorite with high purity in which there is a reduced amount of lime (unreacted lime) remaining as an impurity.

To increase the purity of the produced fluorite, when the hydrofluoric acid waste liquid is applied to the lumps of lime, the reaction is allowed to proceed until the pH becomes acidic at 7 or below (preferably in a range of pH7 to pH5) so that the majority of the lumps of lime can be converted into fluorite of a high purity with the particle diameter of the lime being maintained. It should be noted that by managing the pH as mentioned above, during the discharge process following the production of the fluorite, slaked lime or polyaluminum chloride is applied, so that the process is carried out without exceeding the emission standards set by the Water Pollution Control Law of Japan and the standards set for the factories. In addition, by ending the reaction when the pH is in a range of 5 to 3, fluorite with higher purity is obtained, but in some cases it can become necessary to additionally carry out post-processing to suppress the concentration of fluorine to within emission standards.

### First Exemplary Embodiment

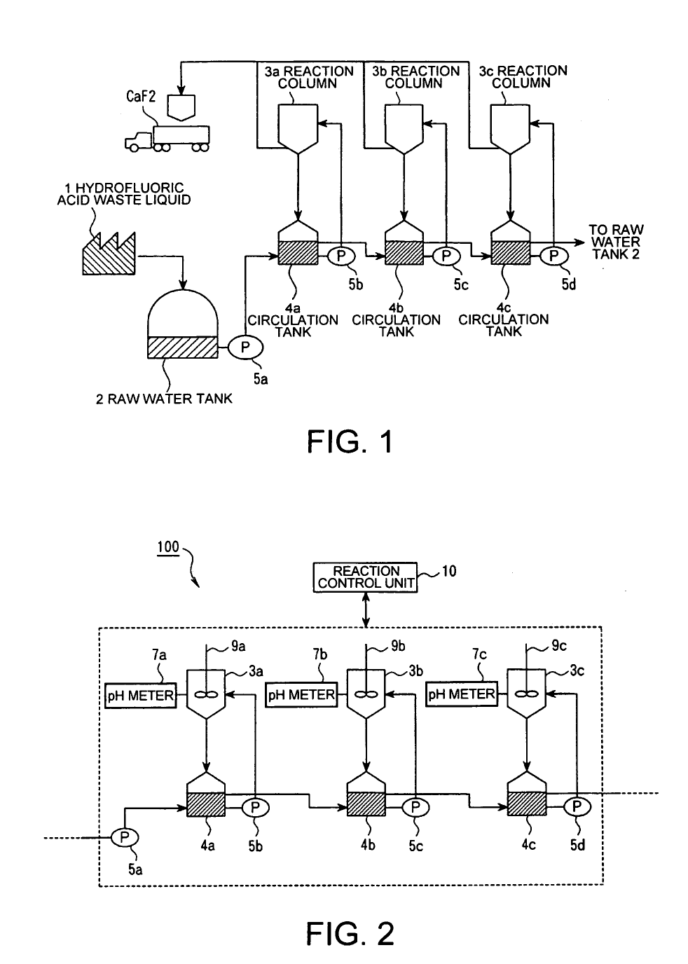

FIG. 1 is a schematic showing the flow of the chemical reprocessing method according to an exemplary embodiment of the present invention. In the present exemplary embodiment, a flow is shown in which hydrofluoric acid waste liquid is caused to react with calcium carbonate (CaCO₃, also referred to as “lime”) to produce calcium fluoride (fluorite) that is recovered.

In the procedure of the recovery process for calcium fluoride (fluorite) in FIG. 1, the recovery system includes a raw water tank 2 that stores the hydrofluoric acid waste liquid 1 recovered from a process that discharges hydrofluoric acid waste liquid of relatively high purity as part of the manufacturing process for a semiconductor device, a plurality (three columns in FIG. 1) of reaction columns 3a, 3b, 3c that produce calcium fluoride (fluorite) by causing the hydrofluoric acid waste liquid to react with calcium carbonate (lime), a plurality (three tanks in FIG. 1) of circulation tanks 4a, 4b, 4c that are provided respectively for the reaction columns 3a, 3b, 3c, that store the hydrofluoric acid waste liquid 1 from the raw water tank 2 respectively for the reaction columns 3a, 3b, 3c, and that also store waste liquid respectively emitted from the reaction columns 3a, 3b, 3c after the hydrofluoric acid waste liquid has reacted with the calcium carbonate (lime) separately for the reaction columns 3a, 3b, 3c and circulate and supply the stored waste liquid to the reaction columns 3a, 3b, 3c, a pump 5a to supply the hydrofluoric acid waste liquid 1 from the raw water tank 2 to the circulation tank 4a, and pumps 5b, 5c, 5d to circulate and supply the waste liquid stored in the respective circulation tanks 4a, 4b, 4c to the reaction columns 3a, 3b, 3c.

In FIG. 1, lumps of calcium carbonate (CaCO₃) are loaded inside the respective reaction columns that are the reaction system and a used chemical (hydrofluoric acid waste liquid) that includes hydrofluoric acid is pumped out of the raw water tank 2 by the pump 5a and so flows into the respective reaction columns 3a, 3b, 3c. In the reaction columns 3a, 3b, 3c, as time passes, the waste liquid is gradually applied to the lumps of calcium carbonate (CaCO₃). The calcium carbonate (CaCO₃) reacts with the hydrofluoric acid (HF) to become calcium fluoride (CaF₂). The equation for this reaction is CaCO₃+2HF→CaF₂+CO₂+H₂O. At this time, the lumps of calcium carbonate (CaCO₃) are gradually penetrated by the hydrofluoric acid waste liquid from the outer part to the inner periphery, so that the above reaction progresses and the calcium carbonate (CaCO₃) is converted into calcium fluoride (CaF₂). The characteristic of this reaction is that the reaction proceeds with the calcium carbonate (CaCO₃) as the core, so that the calcium carbonate (CaCO₃) is gradually converted into calcium fluoride (CaF₂) with the particle diameter being maintained. This means that the average particle diameter of the produced calcium fluoride (CaF₂) is relatively large so that the calcium fluoride (CaF₂) can be easily recovered with a filter cloth.

FIG. 2 is a schematic showing an example construction of a chemical reprocessing apparatus 100, according to the present exemplary embodiment of the invention. The chemical reprocessing apparatus 100 according to the present exemplary embodiment, includes the raw water tank 2, the reaction columns 3a, 3b, 3c, the circulation tanks 4a, 4b, 4c, the pumps 5a, 5b, 5c, 5d shown in FIG. 1 and pH meters 7a, 7b, 7c, agitating vanes 9a, 9b, 9c, a reaction control unit 10, and the like shown in FIG. 2.

As shown in FIG. 2, the agitating vane 9a is provided inside the reaction column 3a and agitates the hydrofluoric acid waste liquid inside the reaction column 3a. In the same way, the agitating vane 9b is provided inside the reaction column 3b and agitates the hydrofluoric acid waste liquid inside the reaction column 3b. The agitating vane 9c is provided inside the reaction column 3c and agitates the hydrofluoric acid waste liquid inside the reaction column 3c. The pH meter 7a measures the pH of the hydrofluoric acid waste liquid inside the reaction column 3a, the pH meter 7b measures the pH of the hydrofluhoric acid waste liquid inside the reaction column 3b, and the pH meter 7c measures the pH of the hydrofluoric acid waste liquid inside the reaction column 3c. The reaction control unit 10 is connected to the pH meters 7a, 7b, 7c, driving systems of the agitating vanes 9a, 9b, 9c, and to driving systems of the pumps 5a, 5b, 5c, 5d respectively via signal lines.

In the chemical reprocessing apparatus 100, based on the measured values given by the pH meters 7a, 7b, 7c, the reaction control unit 10 controls the respective operations of the pumps 5a, 5b, 5c, 5d and the agitating vanes 9a, 9b, 9c.

Also, as the waste liquid including hydrofluoric acid subjected to an exemplary method of the present invention, a waste liquid produced after etching with a wet etchant during a semiconductor manufacturing process is mainly used. In particular, a waste liquid produced after a light wet etching (called “light etching”) of the surface of a substrate, on which films have been formed, with a strong etchant (strong hydrofluoric acid where the ratio of hydrofluoric acid to water is 1:1 or 1:10, for example) during the manufacturing process of a semiconductor may be used. Specifically, the waste liquid should preferably be hydrofluoric acid waste liquid from after a wet etching process related to isolation or after a wet etching process carried out before a thermal process, such as CVD or oxidization. For example, after trenches to isolate elements have been formed in an isolation process, a process that removes parts (an oxide film) of the inner walls of trenches by lightly etching the surface with hydrofluoric acid is carried out and the hydrofluoric acid discharged during this process is recovered.

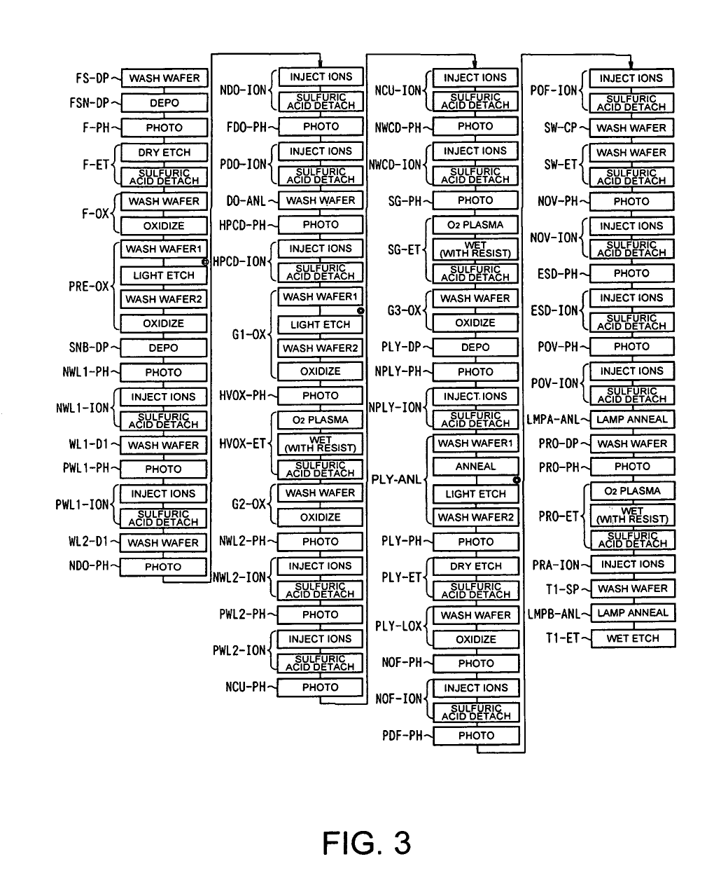

FIG. 3 shows the flow of a semiconductor manufacturing process. In this flow, the characters “FS-DP”, “FSW-DP”, . . . , show the names of the main processes, while the characters in the boxes show the names of smaller processes. The characters “PRE-OX” represent a pre-oxidizing process that forms a sacrificial oxide film for a subsequent ion introducing process, the characters “G1-OX” represent an oxide film forming process to form a gate insulating film, and the characters “PLY-ANL” represent an annealing process that carries out a heat treatment for a polysilicon film. The characters “light etch” are an abbreviation for “light etching” , “depo” is an abbreviation for “deposition”, and “photo” is an abbreviation for “photolithography”. The light etching processes indicated by the double circle on the right side of the names of the small steps are processes in which strong, high-quality hydrofluoric acid with few mixed-in impurities can be recovered as the hydrofluoric acid waste liquid used in the first exemplary embodiment of the present invention. During a wet etching process carried out using hydrofluoric acid, during the process indicated as “wet (with resist)”, a hydrofluoric acid-including chemical including chemicals aside from hydrofluoric acid for resist removal is used. The hydrofluoric acid waste liquid discharged in this process includes many impurities aside from hydrofluoric acid and so is not suited to the hydrofluoric acid waste liquid for use in the first exemplary embodiment of the present invention to recover calcium fluoride (fluorite).

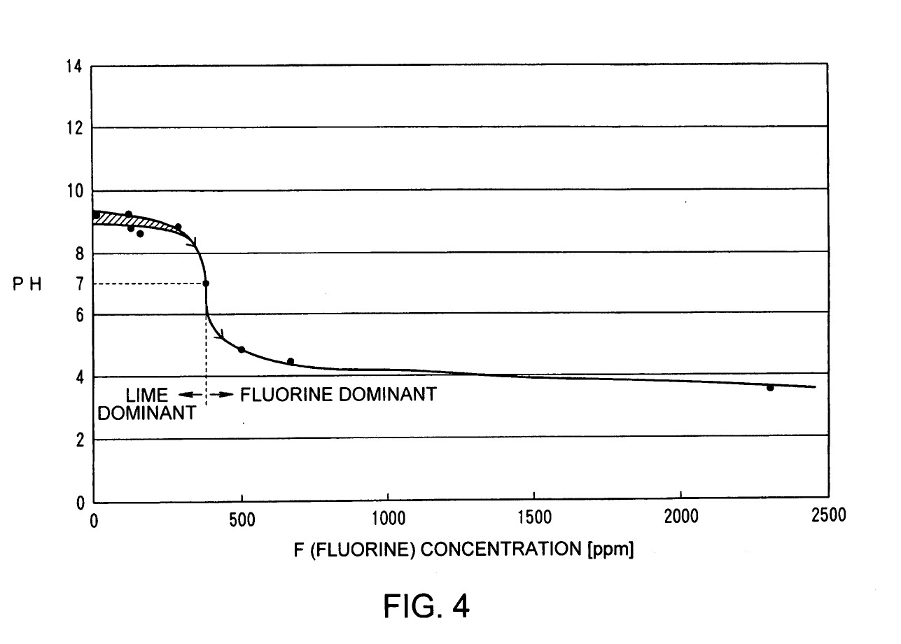

FIG. 4 shows the relationship between the changes in pH in response to an increase in the fluorine concentration (ppm) when the hydrofluoric acid waste liquid is applied to calcium carbonate (lime). Here, ppm has the same meaning as mg/l. The pH of the reaction system is measured by the pH meter 7a and the like (see FIG. 2).

When there is little hydrofluoric acid and the fluorine concentration is 0 ppm, the calcium carbonate (lime) that is slightly alkaline is dominant, so that the pH of the hydrofluoric acid waste liquid is around 9. As the amount of hydrofluoric acid waste liquid increases relatively to the calcium carbonate (lime), the lumps of calcium carbonate gradually react with the hydrofluoric acid and are converted into calcium fluoride. As the concentration of fluorine increases to around 300 ppm, a pH of around 9 is maintained. When the fluorine concentration reaches around 300 to 370 ppm, the reaction with the calcium carbonate proceeds and the pH changes from 9 to 7.

At this time, the majority of the calcium carbonate is converted into calcium fluoride. But the central parts of the lumps of calcium carbonate are not penetrated by the hydrofluoric acid and remain as calcium carbonate without being converted to calcium fluoride. In this state, since the unreacted calcium carbonate remains as an impurity, the purity of the calcium fluoride is around 90%, which means that the purity is insufficient for the hydrofluoric acid used in semiconductor manufacturing.

For this reason, to obtain calcium fluoride that has a purity of close to 98%, that is equivalent to natural fluorite used in semiconductor manufacturing, it is necessary to apply more hydrofluoric acid waste liquid from a state where pH7 is exceeded and to make the pH 7 or below. When the pH is 7 or below, the reaction system changes from a dominance of lime to a dominance of fluorine, so that for example when the concentration of the fluorine is 500 ppm, the pH becomes around 5. In this state, when the reactive state becomes slightly acidic based on the hydrofluoric acid, most of the unreacted calcium carbonate remaining in the central parts of the lumps of calcium fluoride disappears, and it is possible to recover calcium fluoride with a high purity of around 97%.

It should be noted that to increase the purity of the calcium fluoride (fluorite), the pH may be set at 7 or below using the hydrofluoric acid waste liquid, with a pH range of 7-5 being preferable and a pH range of 7-3 being more preferable. If the pH falls, the concentration of fluorine rises, and there is the problem of whether it is possible to suppress the fluorine concentration to the emissions standard of 8 ppm set according to the Water Pollution Control Law and the emissions standard of 5 ppm used in factories. However, in the present exemplary embodiment of the invention, even when calcium fluoride (fluorite) with a high purity of 97% is recovered, by applying a large amount of slaked lime or aluminum polychloride during a discharge process following the recovery of the fluorite, it is possible to satisfy both of the above standards for fluorine concentration.

It should be noted that in paragraph [0011] of Japanese Unexamined Patent Publication No. 2001-137864, it is stated that “the pH of the waste water including ammonium fluoride and the hydrofluoric acid is normally around 1 to 3, and for the process reaction to proceed smoothly, the pH should be adjusted with Ca(OH)₂. However, since ammonia is produced from ammonium sulfate ((NH₄)₂SO₄) when the pH of the reaction system exceeds 7, the pH of the reaction system should preferably be kept at 7 or below. The pH should preferably be 6.5 to 7. Such adjustment of the pH can be carried out while measuring the pH of the reaction system with a pH meter.” This means that when calcium sulfate is added to the waste water including hydrofluoric acid, the pH of the reaction system is adjusted by adding calcium hydroxide to the waste water in advance to keep the pH at 7 or below and so prevent ammonia from being produced.

With the first exemplary embodiment of the present invention described above, in the process where the hydrofluoric acid is gradually added to the lumps of calcium carbonate which react to become calcium fluoride, a state where it is possible to recover calcium fluoride of high purity and with a low water content was detected when the pH was measured (verified) as being at 7 or below. Accordingly, the content of Japanese Unexamined Patent Publication No. 2001-137864 is fundamentally different to the content of the chemical reprocessing method according to exemplary aspects of the present invention.

According to the first exemplary embodiment of the present invention described above, it is possible to optimize the recovery timing of the calcium fluoride, or in other words, the conversion timing of the calcium carbonate, by managing the pH. In addition, high quality fluorite that is close to natural fluorite can be produced and by recycling this as a raw material at a chemical manufacturer, it is possible to produce high grade hydrofluoric acid that can be used in semiconductor manufacturing.

The mining of fluorite is environmentally destructive, so that the exemplary aspects of the present invention have the merits of reducing or preventing the destruction of nature, the ability to reduce hydrofluoric acid waste including chemical waste for chemicals recycled by fluorite recovery (that is, a reduction in sludge), and the promotion of reduced resource use through recycling.

According to an exemplary aspect of the present invention described above, in a chemical reprocessing method that recovers hydrofluoric acid in an etchant waste liquid as calcium fluoride produced by contact with calcium carbonate, it is possible to recover calcium fluoride of high purity that can be used in semiconductor manufacturing and the conversion timing of calcium carbonate can be optimized so that waste can be eliminated for the amount of calcium carbonate used. Also, since calcium carbonate is converted into calcium fluoride with the particle diameter being maintained, calcium fluoride of a suitable particle diameter is obtained, so that the calcium fluoride is easy to handle and can be easily recovered with filter cloth. In addition, the effective usage of resources can be increased by recycling.

It should be noted that the exemplary aspects of the present invention are not limited to a reprocessing method for a waste liquid that includes hydrofluoric acid and, as the recovery and recycling of other chemical waste liquids advances, is effective in optimizing the selection of a chemical that reacts with waste liquid and the replacement timing of the chemical after the reaction.

### Second Exemplary Embodiment

In the first exemplary embodiment, the case where the end of the reaction between the hydrofluoric acid and the lime is fundamentally set at a pH of 7 or below and 5 or above (i.e., in a range of 7 to 5) is described. As shown in FIG. 4, there is the tendency for the concentration of fluorine in the hydrofluoric acid waste liquid to increase as the pH of the hydrofluoric acid waste liquid falls. By setting the pH of the hydrofluoric acid waste liquid at 7 to 5 when the calcium fluoride (fluorite) is recovered, it is possible to suppress the concentration of the fluorine remaining in the hydrofluoric acid waste liquid to a certain extent. However, as described in the first exemplary embodiment, by setting the end of the reaction between the hydrofluoric acid and the lime at a pH of 5 or below and 3 or above (i.e., in a range of 5 to 3), compared to when the end of the reaction is at a pH of 7 to 5, it is possible to recover calcium fluoride with a higher purity.

In this second exemplary embodiment, the type of waste liquid reprocessed by the chemical reprocessing apparatus 100 described above is specified and the end of the reaction between hydrofluoric acid and the lime inside the reaction columns of the chemical reprocessing apparatus 100 is set at a pH of 5 to 3. The recovery of calcium fluoride with higher purity than in the first exemplary embodiment by specifying the processing conditions of the chemical reprocessing apparatus 100 in this way will now be described. A method of post-processing hydrofluoric acid waste liquid with a pH of 5 to 3 discharged from the chemical reprocessing apparatus 100 so as to strictly adhere to legal emissions standards and the emission standards of factories will also be described.

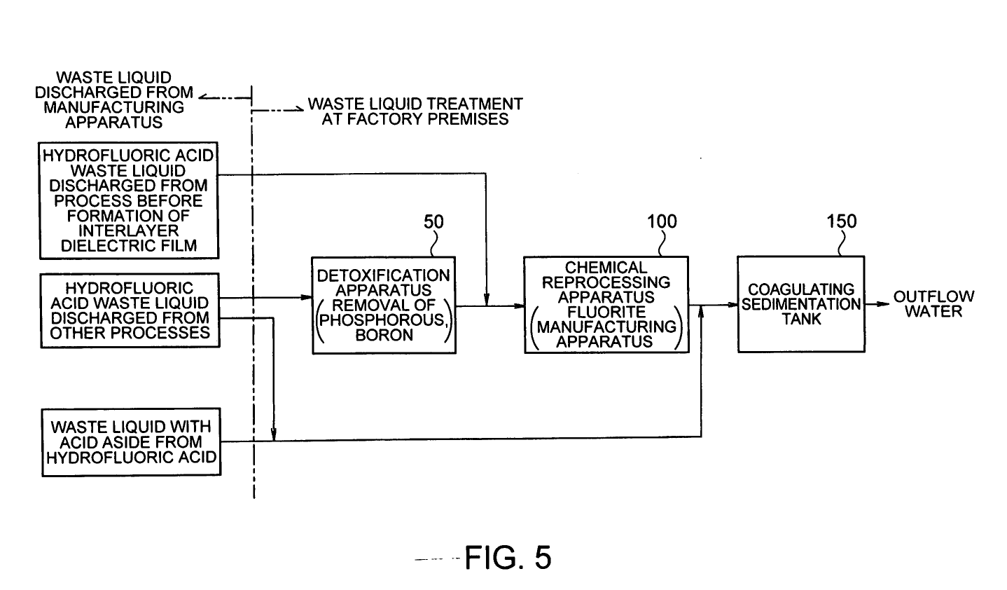

FIG. 5 is a schematic showing an example of the overall construction of a waste liquid processing apparatus according to the present exemplary embodiment of the invention. As shown in FIG. 5, this waste liquid processing system includes a detoxification apparatus 50 that removes impurities, such as boron and phosphorus from the waste liquid, the chemical reprocessing apparatus 100 shown in FIG. 1, and a coagulating sedimentation tank 150 or the like. In the chemical reprocessing apparatus 100, as described in the first exemplary embodiment, the reaction process CaCO₃+2HF→CaF₂+CO₂+H₂O is carried out in the reaction columns, so that CaF₂ is produced from the CaCO₃, which means that the chemical reprocessing apparatus 100 is in other words a fluorite manufacturing apparatus. Also, the arrows drawn as solid lines in FIG. 5 show pipes in the waste liquid processing system, with the directions of the arrows showing the flow of the various types of waste liquid inside the pipes.

As shown in FIG. 5, hydrofluoric acid waste liquid discharged from a process (hereinafter “process before formation of the interlayer dielectric film”) before a process that forms an interlayer dielectric film passes from a waste water outlet of a manufacturing apparatus and through predetermined pipes so as to be sent to the raw water tank 2 (see FIG. 1) of the chemical reprocessing apparatus 100 shown in FIG. 1. Here, processes, such as wet etching relating to isolation, wet etching immediately before the gate oxide film is formed, and wet etching before a thermal process, such as CVD or oxidization can be given as examples the “process before formation of the interlayer dielectric film”, with such processes being marked with double circles in FIG. 3. These processes marked with the double circles are processes before formation of the interlayer dielectric film, such as a BPSG film, PSG, and the like on a wafer, and are processes that can recover high-quality, strong hydrofluoric acid with few mixed-in impurities such as phosphorus and boron.

The hydrofluoric acid waste liquid discharged from processes aside from the processes indicated by the double circles in FIG. 3 (hereinafter “the other processes”) is also sent to the detoxification apparatus 50 and the coagulating sedimentation tank 150 in accordance with factors, such as the type of impurities included in the hydrofluoric acid waste liquid. For example, in a case where the impurities included in the hydrofluoric acid waste liquid discharged from the other processes is one or both of phosphorous and boron, with other impurities (for example, organic matter, such as a resist) hardly being included, the hydrofluoric acid waste liquid is sent to the detoxification apparatus 50. Conversely, when the hydrofluoric acid waste liquid discharged from the other processes includes organic matter such as a resist, the hydrofluoric acid waste liquid is sent directly to the coagulating sedimentation tank 150 without being sent to the detoxification apparatus 50 or the chemical reprocessing apparatus 100.

In addition, as shown in FIG. 5, waste liquid including acid and the like aside from hydrofluoric acid (for example, waste liquid including sulfuric acid) is sent directly to the coagulating sedimentation tank 150 without being sent to the detoxification apparatus 50 or the chemical reprocessing apparatus 100.

Next, as shown in FIG. 5, in the detoxification apparatus 50, the phosphorus and boron are removed from the hydrofluoric acid waste liquid discharged from the other processes and sent to the detoxification apparatus 50. After the phosphorus and boron have been removed, the hydrofluoric acid waste liquid is sent to the raw water tank 2 (see FIG. 1) of the chemical reprocessing apparatus 100. Aside from the setting of the pH of the reaction end, the processing method of the hydrofluoric acid waste liquid in the chemical reprocessing apparatus 100 is the same as in the first exemplary embodiment.

That is, as shown in FIG. 1, the lumps of calcium carbonate are set inside the respective reaction columns 3a, 3b, 3c that are the reaction system, and hydrofluoric acid waste liquid sent from the processes before formation of the interlayer dielectric film and from the detoxification apparatus 50 is pumped out of the raw water tank 2 using a pump and flows inside the respective reaction columns 3a, 3b, 3c. In the reaction columns 3a, 3b, 3c, the hydrofluoric acid waste liquid is gradually applied to the lumps of calcium carbonate as time passes and the calcium carbonate progressively reacts with the hydrofluoric acid to become calcium fluoride. The characteristic of this reaction is that the reaction proceeds with the calcium carbonate as the core, so that the calcium carbonate is progressively converted into calcium fluoride with the particle diameter unchanged.

In the second exemplary embodiment, the amount of hydrofluoric acid waste liquid in the respective reaction columns 3a, 3b, 3c relative to the calcium carbonate (lime) is large, so that the pH of the hydrofluoric acid waste liquid (in other words, the reaction system) inside the reaction columns 3a, 3b, 3c is set at 5 or below. Since the pH of the reaction system becomes around 7 to 5, the reaction system changes to a state where fluorine is dominant, so that the fluorine concentration in the hydrofluoric acid waste liquid becomes around 200 to 500 ppm, for example. Hydrofluoric acid waste liquid is additionally introduced into the reaction columns 3a, 3b, 3c and the pH of the reaction system approaches 3. As the pH of the reaction system approaches 3, the concentration of fluorine in the hydrofluoric acid waste liquid becomes around 2000 ppm to 3000 ppm, for example (see FIG. 4). In this state where the pH is 5 to 3, most of the unreacted calcium carbonate remaining in the center parts of the lumps of calcium fluoride disappears, and the purity of the calcium fluoride is increased to around 98%.

The pH of the hydrofluoric acid waste liquid inside the respective reaction columns 3a, 3b, 3c is in a range of 5 to 3, and as the value approaches 3, the reaction between the hydrofluoric acid and the calcium carbonate is ended and the calcium fluoride is recovered from the reaction columns 3a, 3b, 3c. The recovery of calcium fluoride can be carried out using filter cloth, for example. It should be noted that in the chemical reprocessing apparatus 100, the setting condition (the reaction speed v) for obtaining a good yield of calcium fluoride with a purity of 98% or above with high efficiency will be described in the third exemplary embodiment below.

The hydrofluoric acid waste liquid after reprocessing by the chemical reprocessing apparatus 100 is sent from the chemical reprocessing apparatus 100 to the coagulating sedimentation tank 150 via the pipes. In the coagulating sedimentation tank 150, one or any combination of a) to c) below is used as a fluorine absorbing agent.
a) Slaked lime (Ca(OH)₂)+polyaluminum chloride (PAC)
b) A rare earth (such as lanthanoid)
c) A chelating agent

By using this kind of fluorine absorbing agent, the majority of the fluorine in the hydrofluoric acid waste liquid is removed from the hydrofluoric acid waste liquid as sludge, so that the concentration of fluorine in the waste liquid (hereinafter “outflow water”) that flows out of the waste liquid processing system can be suppressed to within the emissions standard of 8 ppm according to the Water Pollution Control Law and the emissions standard of 5 ppm used in factories.

According to the second exemplary embodiment of the present invention, to increase the purity of the calcium fluoride (fluorite), the end of the reaction between the hydrofluoric acid and the lime is set at a pH of between 5 and 3. Accordingly, compared to the case where the end of the reaction is set at a pH between 7 and 5, the pH of the hydrofluoric acid waste liquid that is discharged from the chemical reprocessing apparatus 100 is high and the concentration of fluorine is also high, so that there is an increase in the amount of sludge produced in the coagulating sedimentation tank 150.

However, it is possible to raise the purity of the calcium fluoride (fluorite) recovered from the chemical reprocessing apparatus 100 to around 98%. Accordingly, it is possible to obtain high quality calcium fluoride that is close to natural fluorite (with a purity of 98%), so that with the obtained calcium fluoride as a raw material, it is possible to recycle hydrofluoric acid of a high grade that can be used in semiconductor manufacturing, for example.

### Third Exemplary Embodiment

In the third exemplary embodiment, an example of favorable setting conditions (the reaction speed v) to obtain calcium fluoride (fluorite) with a purity of 98% or above with high efficiency in the chemical reprocessing apparatus 100 shown in FIG. 1 and FIG. 2 will be described. The favorable setting conditions of the chemical reprocessing apparatus 100 obtained from actual measurement data are as shown below.

Flow rate of hydrofluoric acid waste liquid . . . 2 t/hr or less
Total amount of calcium carbonate used per reprocessing . . . 3.2 t
Time required per reprocessing . . . 2 months (=24 hr/d×30 d/m×2 m)
Agitation speed by the agitation vanes . . . 1000 rpm

Here, “t” represents tons, “d” represents days, and “m” represents months, while “rpm” means “revolutions per minute”. With these setting conditions, the reaction speed v is shown by Equation (1) below.

Equation (1)
v=10⁻³×{(2 t/hr)×(24 hr/d)×(30 d/m)×2 m}/3.2 t=0.9[ton^{-F}/ton^{-CaCO3}] (1)

As shown in Equation (1), in the chemical reprocessing apparatus 100, by setting the reaction speed v at 0.9 [ton^{-F}/ton^{-CaCO3}] or below, it is possible to obtain fluorite with a purity of around 98% with high efficiency and with a high yield.

In the first to third exemplary embodiments described above, the manufacturing process of a semiconductor apparatus corresponds to a manufacturing process for an electronic device for an exemplary aspect of the present invention. The pH meters 7a, 7b, 7c correspond to pH measuring device for an exemplary aspect of the present invention control unit 10 corresponds to a reaction control device for exemplary resent invention.

It should be noted that although the above first to third exemplary embodiments have been described by way of a manufacturing process of a semiconductor apparatus as one example of a manufacturing process for an electronic device for exemplary aspects of the present invention, the “manufacturing process for an electronic device” for the present invention is not limited to this, and can be a manufacturing process for an LCD, for example.

1. A chemical reprocessing method that includes hydrofluoric acid used in a semiconductor manufacturing process, comprising:
producing calcium fluoride by causing a used chemical including hydrofluoric acid to react with calcium carbonate, the calcium fluoride being produced starting from a state where a pH exceeds 7 and the calcium fluoride being recovered when the pH becomes 7 or below.

2. A chemical reprocessing method that recovers calcium fluoride by gradually applying a used chemical, which includes hydrofluoric acid and has been discharged by a semiconductor manufacturing process, to a reaction system loaded with calcium carbonate and causing the chemical to react with the calcium carbonate, comprising:
measuring a pH of the reaction system and recovering the calcium fluoride when it has been detected that the reaction system has changed from a calcium carbonate dominant state to a fluorine dominant state.

3. A chemical reprocessing method that recovers calcium fluoride by gradually applying a used chemical, which includes hydrofluoric acid and has been discharged by a semiconductor manufacturing process, to a reaction system loaded with calcium carbonate and causing the chemical to react with the calcium carbonate, comprising:
measuring a pH of the reaction system, ending a reaction when the pH has become 7 or below, and recovering the calcium fluoride.

4. A chemical reprocessing method that recovers calcium fluoride by gradually applying a used chemical, which includes hydrofluoric acid and has been discharged by a semiconductor manufacturing process, to a reaction system loaded with calcium carbonate and causing the chemical to react with the calcium carbonate, comprising:
a chemical produced after lightly etching a surface of a substrate on which a film has been formed with strong hydrofluoric acid during a semiconductor manufacturing process being used as the used chemical including hydrofluoric acid.

5. A chemical reprocessing method that recovers calcium fluoride by gradually applying a used chemical, which includes hydrofluoric acid and has been discharged by a semiconductor manufacturing process, to a reaction system loaded with calcium carbonate and causing the chemical to react with the calcium carbonate, a chemical produced after lightly etching a surface of a substrate on which a film has been formed with strong hydrofluoric acid during a semiconductor manufacturing process being used as the used chemical and including hydrofluoric acid, the method comprising:
measuring a pH of the reaction system;
ending a reaction when the pH has become 7 or below; and recovering the calcium fluoride.

6. The chemical reprocessing method according to claim 1, the pH at an end of a reaction being set at 7 to 5.

7. The chemical reprocessing method according to claim 1, the pH at an end of a reaction being set at 7 to 3.

8. A chemical reprocessing method that recovers hydrofluoric acid from a used chemical by applying the used chemical, which includes hydrofluoric acid and has been discharged by a manufacturing process for an electronic device, to a reaction system loaded with calcium carbonate and causing the hydrofluoric acid to react with the calcium carbonate to produce calcium fluoride, the method comprising:
measuring a pH of the reaction system in which the used chemical has been introduced; and
ending a reaction between the hydrofluoric acid and the calcium carbonate in the reaction system when a measured value of the pH becomes 7 or below and recovering the calcium fluoride from the reaction system.

9. The chemical reprocessing method according to claim 8, the reaction between the hydrofluoric acid and the calcium carbonate in the reaction system being ended when the measured value of the pH becomes 5 or below or 3 or above and the calcium fluoride being recovered from the reaction system.

10. The chemical reprocessing method according to claim 8, further comprising:
removing impurities from the used chemical that includes the hydrofluoric acid and has been discharged from the manufacturing process of the semiconductor device and then introducing the used chemical from which the impurities have been removed into the reaction system in which the calcium carbonate has been loaded.

11. The chemical reprocessing method according to claim 8, only the used chemical discharged from a process, out of the manufacturing process of an electronic device, before formation of an interlayer dielectric film being introduced into the reactive system in which the calcium carbonate has been loaded.

12. The chemical reprocessing method according to claim 8, a predetermined fluorine absorbing agent being applied to the used chemical for which the reaction between the hydrofluoric acid and the calcium carbonate has been ended.

13. A chemical reprocessing apparatus, comprising:
a reaction column in which a used chemical, which includes hydrofluoric acid and has been discharged from a manufacturing process of an electronic device, is caused to react with calcium carbonate to produce calcium fluoride;
pH measuring device to measure a pH of the used chemical inside the reaction column; and
reaction controlling device to end a reaction between the hydrofluoric acid and the calcium carbonate inside the reaction column when a measured value for the pH produced by the pH measuring device has become at least 7 or below,
the calcium fluoride being recovered from inside the reaction column after the reaction has been ended.

14. A method of manufacturing calcium fluoride (fluorite) by introducing a used chemical, which includes hydrofluoric acid and has been discharged from a manufacturing process for an electronic device, into a reaction system in which calcium carbonate has been loaded and causing the hydrofluoric acid to react with the calcium carbonate, the method comprising:
measuring a pH of the reactive system into which the used chemical has been introduced;
ending a reaction between the hydrofluoric acid and the calcium carbonate in the reaction column when a measured value of the pH has become at least 7 or below; and
recovering the calcium fluoride from the reaction column.
